(19) United States
(12) Patent Application Publication
(10) Pub. No.: US 2018/0299068 A1
(43) Pub. Date: Oct. 18, 2018

(54) LIQUEFIED GAS STORAGE TANK AND MANUFACTURING METHOD THEREFOR

(71) Applicant: DAEWOO SHIPBUILDING & MARINE ENGINEERING CO., LTD., Seoul (KR)

(72) Inventors: Seong Woo PARK, Geoje-si (KR); Kwang Jun PARK, Seoul (KR)

(21) Appl. No.: 15/768,809

(22) PCT Filed: Mar. 28, 2016
(86) PCT No.: PCT/KR2016/003101

§ 371 Date: Apr. 16, 2018

(30) Foreign Application Priority Data
Oct. 28, 2015 (KR) 10-2015-0149823

(51) Int. Cl. F17C 3/02; F17C 3/06; F17C 13/00

(52) U.S. Cl. CPC F17C 3/027; F17C 3/06; F17C 13/001; F17C 2203/0358; F17C 2203/0643; F17C 2270/0118; F17C 2203/0682; F17C 2205/0352; F17C 2209/232; F17C 2221/033; F17C 2223/0161; F17C 2203/0651

(57) ABSTRACT

A liquefied gas storage tank and a manufacturing method therefor are disclosed. According to the present invention, in the liquefied gas storage tank, the material of a membrane, which is adjacent to a region in which a liquid dome is installed, is different from the material of a membrane, which is not adjacent thereto, such that the liquefied gas storage tank can effectively respond to the thermal deformation generated during the storage of liquefied gas.

### TECHNICAL FIELD

The present invention relates to a liquefied gas storage tank and a method of manufacturing the same.

### BACKGROUND ART

Generally, a floating offshore structure configured to handle liquefied gas such as liquefied natural gas (LNG) is provided with a liquefied gas storage tank. Since liquefied gas is stored at cryogenic temperatures much lower than room temperature, such a liquefied gas storage tank is formed of a material capable of withstanding cryogenic temperatures. In addition, the liquefied gas storage tank generally includes an insulator for preventing heat exchange with an external environment.

A liquefied gas storage tank is provided in the inside and outside thereof with pipes for supplying/discharging liquefied gas to/from the storage tank, in which a liquid dome may be provided to a portion of the storage tank through which the pipes pass.

### DISCLOSURE

### Technical Problem

A liquefied gas storage tank is divided into an independent type storage tank and a membrane-type storage tank depending on whether an insulator thereof directly receives a load of liquefied gas.

Particularly, in the membrane-type storage tank, since membranes of the storage tank directly or indirectly contact liquefied gas at cryogenic temperature, the membranes can suffer from shrinkage due to thermal deformation. Thus, in manufacture of the storage tank, the membranes are formed with corrugations to cope with shrinkage due to thermal deformation.

However, it is technically difficult to form corrugations on a membrane adjacent to a liquid dome due to the characteristics of a storage tank manufacturing method.

Therefore, it is an object of the present invention to provide a liquefied gas storage tank which can cope with thermal deformation of a membrane adjacent to a liquid dome without corrugating the membrane, and a method of manufacturing the same.

### Technical Solution

In accordance with one aspect of the present invention, a liquefied gas storage tank includes: a first membrane, a first panel, a second membrane, and a second panel, which are sequentially stacked; and a liquid dome disposed at an upper side of the liquefied gas storage tank, the liquid dome being provided with a pipe through which liquefied gas is supplied to or discharged from the liquefied gas storage tank, wherein at least one of the first membrane and the second membrane includes an adjacent region adjacent to the liquid dome and a non-adjacent region not adjacent the liquid dome, the adjacent region and the non-adjacent region being formed of different materials.

The adjacent region may be formed of a material having lower thermal strain than that of the non-adjacent region.

The adjacent region may be formed of Invar.

The non-adjacent region may be formed of stainless steel or high-manganese steel.

The non-adjacent region may be formed with corrugations and the adjacent region may not be formed with corrugations.

Among the first membrane and the second membrane, the membrane including the adjacent region and the non-adjacent region formed of different materials may include an end cap for preventing leakage of liquefied gas through the corrugations.

The liquid dome may include: a liquid dome panel; and a liquid dome membrane, wherein the liquid dome membrane may comprise Invar.

In accordance with another aspect of the present invention, a method of manufacturing a liquefied gas storage tank, includes: disposing a first panel; disposing a first membrane on the first panel; disposing a second panel on the first membrane; disposing a second membrane on the second panel; and disposing a liquid dome at upper side of the tank, the liquid dome being provided with a pipe through which liquefied gas is supplied to or discharged from the liquefied gas storage tank; wherein at least one of the first membrane and the second membrane includes an adjacent region adjacent to the liquid dome and a non-adjacent region not adjacent the liquid dome, the adjacent region and the non-adjacent region being formed of different materials.

The adjacent region may be formed of a material having lower thermal strain than that of the non-adjacent region.

The adjacent region may be formed of Invar.

The non-adjacent region may be formed of stainless steel or high-manganese steel.

The non-adjacent region may be formed with corrugations and the adjacent region may not be formed with corrugations.

Among the first membrane and the second membrane, the membrane including the adjacent region and the non-adjacent region formed of different materials may include an end cap for preventing leakage of liquefied gas through the corrugations.

The liquid dome may include: a liquid dome panel; and a liquid dome membrane, wherein the liquid dome membrane may comprise Invar.

### Advantageous Effects

According to the present invention, it is possible to manufacture a liquefied gas storage tank that can cope with thermal deformation of a membrane, without corrugating the membrane adjacent to a liquid dome.

### DESCRIPTION OF DRAWINGS

FIG. 1 to FIG. 9 are views of a liquefied gas storage tank according to one embodiment of the present invention and a method of fabricating the same.

FIG. 10 is a view of the liquefied gas storage tank according to the embodiment of the present invention in which a first panel, a first membrane, a second panel and a second membrane are stacked.

### BEST MODE

Hereinafter, embodiments of the present invention will be described in detail with reference to the accompanying drawings. However, it should be understood that the following embodiments are provided for illustration only and are not to be construed in any way as limiting the present invention, and that various modifications, changes, alterations, and equivalent embodiments can be made by those skilled in the art without departing from the spirit and scope of the invention. Therefore, the scope of the present invention should be defined by the appended claims and equivalents thereof.

As used herein, the term “liquefied gas” should be construed as including liquefied natural gas and liquefied petroleum gas.

In addition, it should be understood that the accompanying drawings are intended to show a liquefied gas storage tank according to one embodiment of the present invention and one example of a method of manufacturing the same and are not to be in any way construed as limiting the present invention.

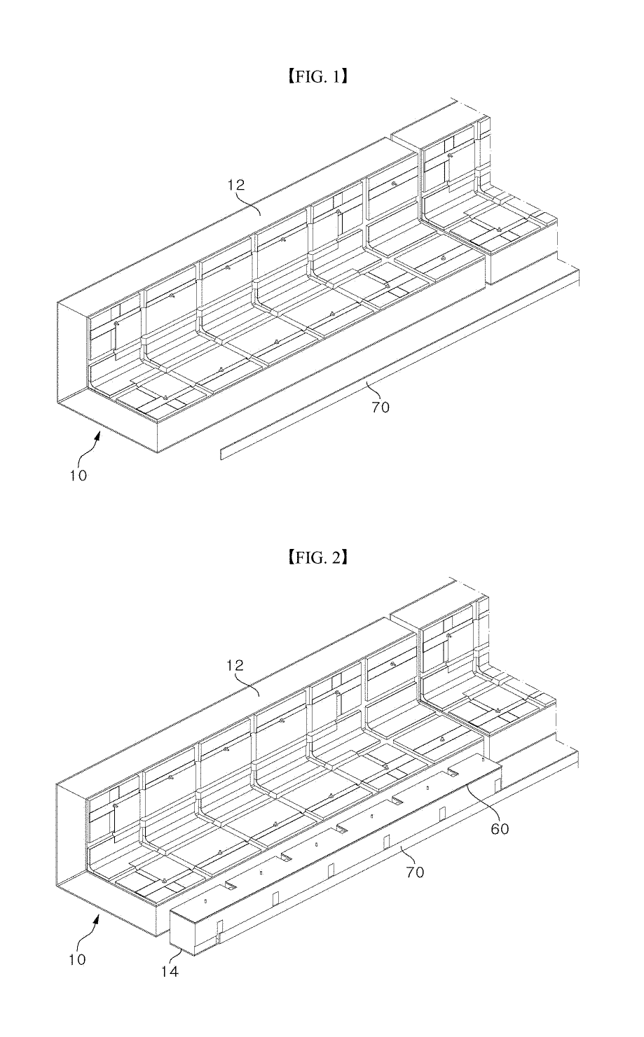

FIG. 1 to FIG. 9 are views of a liquefied gas storage tank according to one embodiment of the present invention and a method of fabricating the same.

Referring to FIG. 1 and FIG. 2, a liquefied gas storage tank according to this embodiment includes a first panel 10. The first panel 10 serves to prevent heat exchange between the inside and the outside of the liquefied gas storage tank and includes an insulator. In addition, the first panel 10 may be a combination of a plurality of unit panels rather than a single-piece component. For example, the first panel 10 may include a first corner panel 12 constituting a corner of the liquefied gas storage tank and a first flat panel 14 constituting a flat portion of the liquefied gas storage tank.

In addition, the first panel 10 may be provided on an upper side thereof with an anchoring plate 60, as shown in FIG. 2. A first membrane 20 may be disposed on an upper side of the anchoring plate 60, as described further below. The anchoring plate 60 may have a thickness of 4 mm to 20 mm.

Further, the first panel 10 may be provided at a side surface thereof with a boundary plate 70. The boundary plate 70 may be attached to the side surface of the first panel 10 and serves to distinguish a region in which a liquid dome is disposed from the other regions, as described further below. A first Invar membrane may be attached to the boundary plate 70 by welding.

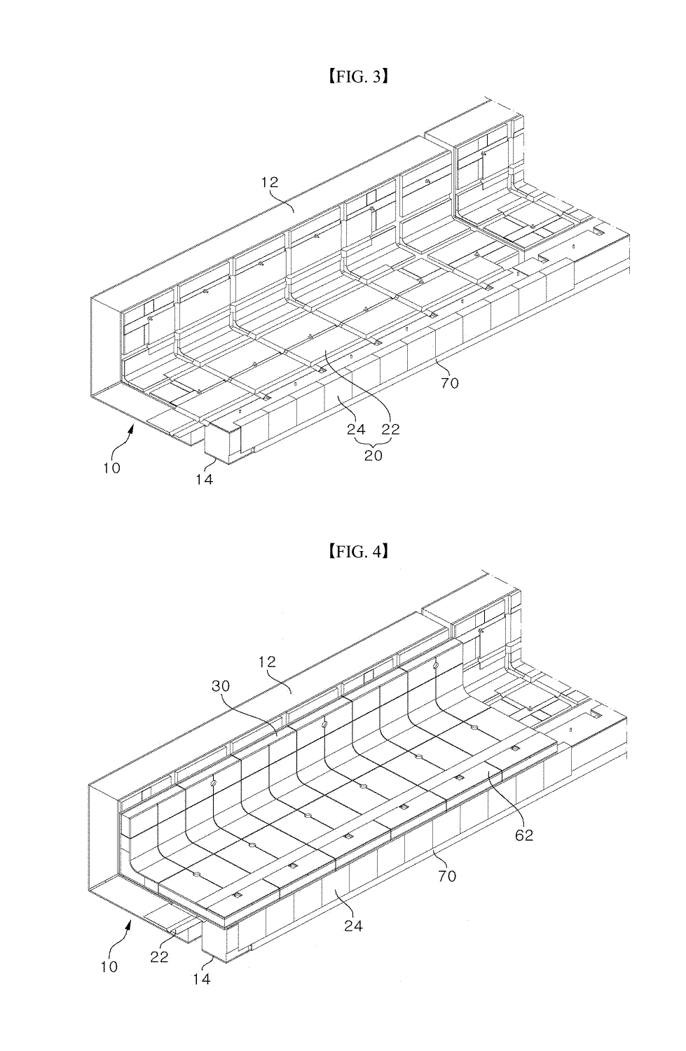

Referring to FIG. 3, the first membrane 20 is disposed on the upper side of the first panel 10 (if an anchoring plate is provided, on the upper side of the anchoring plate). The first membrane 20 is configured to prevent leakage of liquefied gas to the outside and serves to prevent liquefied gas escaping through a second membrane described below, which directly contacts liquefied gas, from leaking to the outside.

In this embodiment, the first membrane 20 may include two components formed of different materials. That is, the first membrane 20 may include a first stainless steel membrane 22 formed of stainless steel and a first Invar membrane 24 formed of Invar. The first stainless steel membrane 22 may have a thickness of 0.5 mm to 3 mm and the first Invar membrane 24 may have a thickness of 0.5 mm to 3 mm. A liquid dome is disposed in a region adjacent to the first invar membrane 24 on the right side of FIG. 3, as described below.

Referring to FIG. 4, the first membrane 20 is provided on an upper side thereof with the second panel 30. Similarly to the first panel 10, the second panel 30 is configured to prevent heat exchange between the inside and outside of the liquefied gas storage tank and includes an insulator.

In addition, similarly to the first panel 10, the second panel 30 may be provided on an upper side thereof with an anchoring plate 62, as shown in FIG. 4. A second membrane 40 may be disposed on an upper side of the anchoring plate 62, as described further below. The anchoring plate 62 may have a thickness of 4 mm to 20 mm.

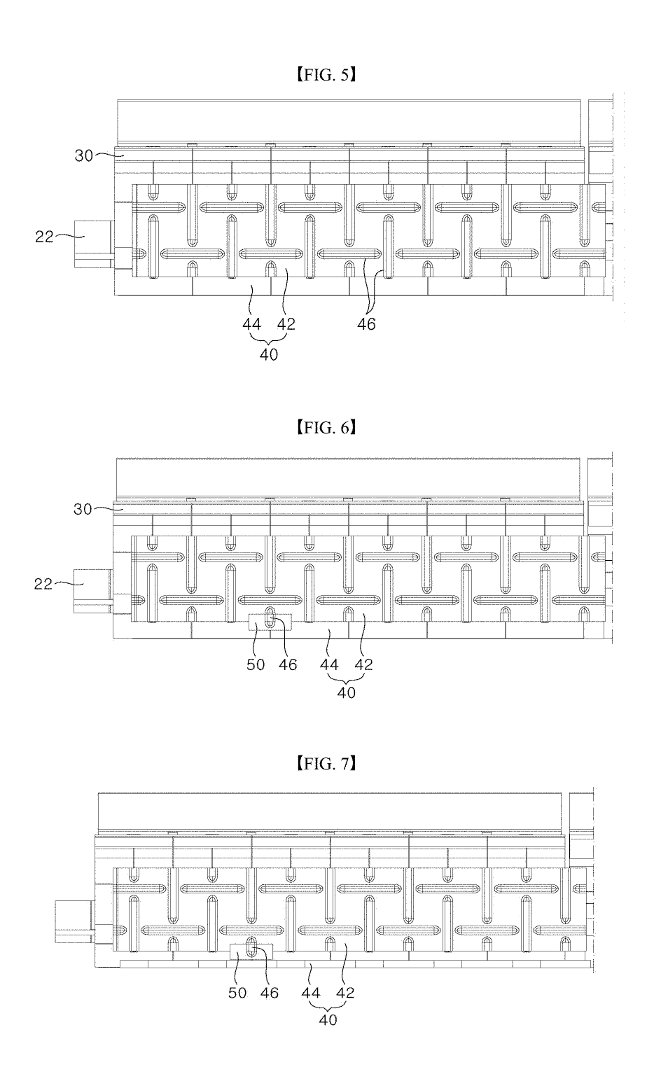

Referring to FIG. 5 to FIG. 7, the second membrane 40 is stacked on the upper side of the second panel 30 (if an anchoring plate is provided, on the upper side of the anchoring plate). The second membrane 40 directly contacts liquefied gas and serves to prevent liquefied gas from leaking to the outside.

In this embodiment, like the first membrane 20, the second membrane 40 may include two components formed of different materials. That is, the second membrane 40 may include a second stainless steel membrane 42 formed of stainless steel and a second Invar membrane 44 formed of Invar. The second stainless steel membrane 42 may have a thickness of 0.5 mm to 3 mm and the second Invar membrane 44 may have a thickness of 0.5 mm to 3 mm.

Compared with just after the completion of the production of the liquefied gas storage tank, the second membrane directly contacting liquefied gas stored in the liquefied gas storage tank is at cryogenic temperature. Thus, the second membrane can be thermally deformed due to cryogenic temperature. In consideration of this problem, the second stainless steel membrane 42 of the second membrane 40 may be formed with corrugations 46 in manufacture of the liquefied gas storage tank.

Stainless steel may be used in cryogenic applications such as storage of liquefied gas due to high resistance to brittleness thereof, but has a high thermal strain of about 0.175% per degree Celsius. Accordingly, a stainless steel membrane in use suffers from very high thermal deformation, as compared with an as-manufactured stainless steel membrane.

According to this embodiment, when the second stainless steel membrane 42 is thermally deformed due to liquefied gas stored in the liquefied storage tank, the corrugations 46 of the second stainless steel membrane are smoothed to cope with thermal deformation due to cryogenic temperature.

Conversely, Invar has a thermal strain of about 0.015% per degree Celsius and thus suffers from much lower thermal deformation than stainless steel. Thus, the second Invar membrane 44 does not need to be corrugated.

Although the corrugations are shown as discontinuously formed in this embodiment, it should be understood that the present invention is not limited thereto and the corrugations may be continuously formed throughout the membrane. In addition, the above description relating to the second membrane 40 may also be applied to the first membrane 20. That is, the first stainless steel membrane 22 of the first membrane 20 may be formed with corrugations and the first Invar membrane 24 may not be formed with corrugations. The reason why the first stainless steel membrane 22 is formed with corrugations and the first invar membrane 24 is not formed with corrugations is the same as described in the second membrane.

Referring to FIG. 6, the corrugations 46 may be provided at an upper portion thereof with an end cap 50.

As described above, the second stainless steel membrane 42 (or the first stainless steel membrane 22) is provided with the corrugations to cope with thermal deformation due to liquefied gas at cryogenic temperature. However, liquefied gas can leak through a gap between the corrugations. In order to prevent such a problem, the upper portion of the corrugations 46 may be covered with the end cap 50 impermeable to liquefied gas. It should be understood that, when the first stainless steel membrane 22 is formed with corrugations, the upper portion of the corrugations of the first stainless steel membrane 22 may be covered with an end cap.

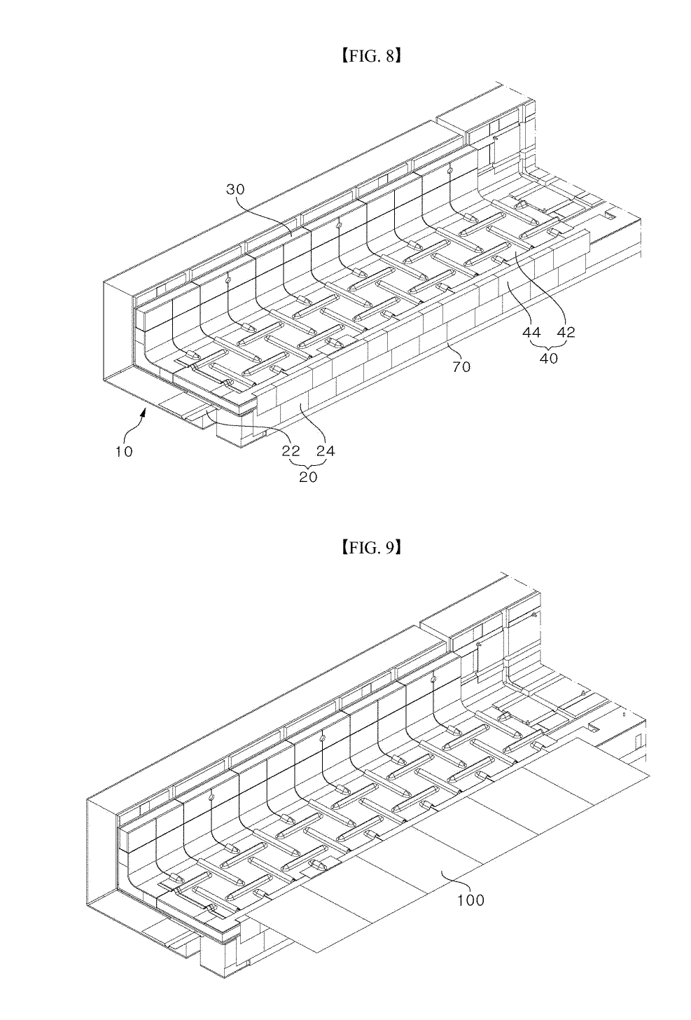

FIG. 8 is a schematic view of the liquefied gas storage tank according to the embodiment of the present invention with a liquid dome removed therefrom.

Referring to FIG. 8, the first membrane 20 may be disposed on the first panel 10 and the second panel 30 may be disposed on the first membrane 20. The second membrane 40 may be disposed on the second panel 30.

In addition, the first Invar membrane 24 may be attached to the boundary plate 70 and the second Invar membrane 44 may be attached to the first Invar membrane 24.

As described above, the boundary plate 70 serves to distinguish the region in which a liquid dome is disposed from the other areas.

According to the present invention, a membrane adjacent to the liquid dome may be formed of a different material than a membrane not adjacent to the liquid dome. That is, the first Invar membrane 24 secured to the boundary plate 70 and the second Invar membrane 44 secured to the first Invar membrane 24 are membranes adjacent to the liquid dome, whereas the other membranes are membranes not adjacent to the liquid dome. As used in the specification and the appended claims, the terms “adjacent region” and “nonadjacent region” are intended to represent positional relationship between a certain membrane and the liquid dome. Thus, membranes in the “adjacent region” may refer to membranes adjacent to the liquid dome, that is, the first Invar membrane 24 and the second Invar membrane 44, and membranes in the “nonadjacent region” may refer to membranes of the first and second membranes 20, 40 other than the first Invar membrane 24 and the second Invar membrane 44, that is, the first stainless steel membrane 22 and the second stainless steel membrane 42.

Referring to FIG. 9, the liquefied gas storage tank according to the embodiment includes a liquid dome. According to the embodiment, the liquid dome is disposed in a region adjacent to the first Invar membrane 24 and the second Invar membrane 44.

The liquid dome includes: a liquid dome panel including an insulator similar to that of the liquefied gas storage tank; and a liquid dome membrane 100 impermeable to liquefied gas. In FIG. 9, only the liquid dome membrane 100 is shown.

The liquid dome membrane 100 is also exposed to liquefied gas and is thus at cryogenic temperature. Thus, the liquid dome membrane 100 may be configured to have a low thermal strain at cryogenic temperature. For example, the liquid dome membrane 100 may comprise an Invar material. Thus, the second Invar membrane 44 and the liquid dome membrane 100 may be formed of the same material (i.e., Invar) and thus can be connected to each other by welding.

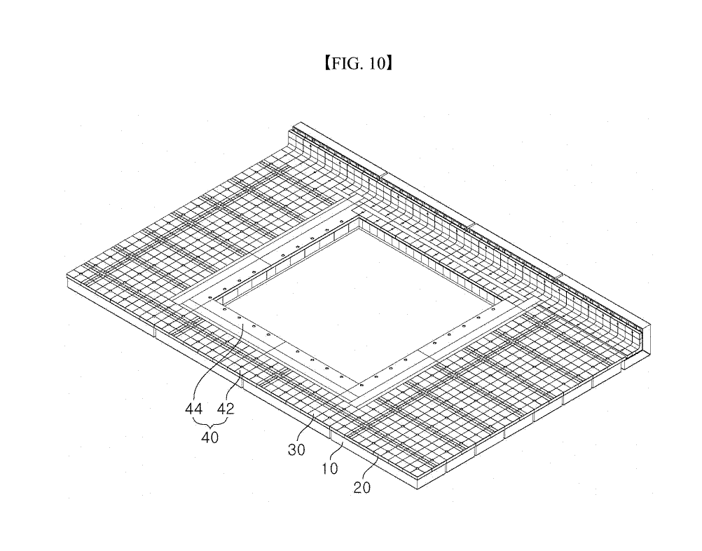

FIG. 10 is a view of the liquefied gas storage tank according to the embodiment of the present invention in which the first panel, the first membrane, the second panel, and the second membrane are stacked.

Referring to FIG. 10, the liquefied gas storage tank according to this embodiment has a structure in which the first panel 10, the first membrane 20, the second panel 30, and the second membrane 40 are stacked in that order. As shown in FIG. 10, an empty space is formed at the center of the structure in which the first panel 10, the first membrane 20, the second panel 30 and the second membrane 40 are stacked in the stated order such that the liquid dome is disposed in the empty space. A method of connecting the liquid dome to the liquefied gas storage tank is described above.

Although a membrane used in a liquefied gas storage tank is generally formed with corrugations to cope with thermal deformation, it is technically difficult to form such corrugations on a membrane around a liquid dome provided with a pipe through which liquefied gas flows.

According to the present invention, among membranes of the liquefied gas storage tank, a membrane adjacent to the liquid dome is formed of a material having low thermal strain (for example, Invar) and thus can cope with thermal deformation without being formed with corrugations.

In another embodiment, components corresponding to the first stainless steel membrane 22 and the second stainless steel membrane 42 may be formed of high-manganese steel rather than stainless steel. Since high-manganese steel is less expensive than stainless steel and is highly resistant to thermal deformation, the object of the present invention can be achieved even when high-manganese steel is used instead of stainless steel.

### LIST OF REFERENCE NUMERALS

1: liquid dome

10: first panel

12: first corner panel

14: first flat panel

20: first membrane

22: first stainless steel membrane

24: first Invar membrane

30: second panel

40: second membrane

42: second stainless steel membrane

44: second Invar membrane

46: corrugations

50: end cap

60, 62: anchoring plate

70: boundary plate

100: liquid dome membrane

1. A liquefied gas storage tank comprising:
a first membrane, a first panel, a second membrane, and a second panel, which are sequentially stacked; and
a liquid dome disposed at an upper side of the liquefied gas storage tank, the liquid dome being provided with a pipe through which liquefied gas is supplied to or discharged from the liquefied gas storage tank,
wherein at least one of the first membrane and the second membrane comprises an adjacent region adjacent to the liquid dome and a non-adjacent region not adjacent the liquid dome, the adjacent region and the non-adjacent region being formed of different materials.

2. The liquefied gas storage tank according to claim 1, wherein the adjacent region is formed of a material having lower thermal strain than that of the non-adjacent region.

3. The liquefied gas storage tank according to claim 1, wherein the adjacent region is formed of Invar.

4. The liquefied gas storage tank according to claim 1, wherein the non-adjacent region is formed of stainless steel or high-manganese steel.

5. The liquefied gas storage tank according to claim 1, wherein the non-adjacent region is formed with corrugations and the adjacent region is not formed with corrugations.

6. The liquefied gas storage tank according to claim 5, wherein, among the first membrane and the second membrane, the membrane comprising the adjacent region adjacent and the non-adjacent region formed of different materials comprises an end cap for preventing leakage of liquefied gas through the corrugations.

7. The liquefied gas storage tank according to claim 5, wherein the liquid dome comprises: a liquid dome panel; and a liquid dome membrane, the liquid dome membrane comprising Invar.

8. A method of manufacturing a liquefied gas storage tank, comprising:
disposing a first panel;
disposing a first membrane on the first panel;
disposing a second panel on the first membrane;
disposing a second membrane on the second panel; and
disposing a liquid dome at an upper side of the tank, the liquid dome being provided with a pipe through which liquefied gas is supplied to or discharged from the liquefied gas storage tank;
wherein at least one of the first membrane and the second membrane comprises an adjacent region adjacent to the liquid dome and a non-adjacent region not adjacent the liquid dome, the adjacent region and the non-adjacent region being formed of different materials.

9. The method according to claim 8, wherein the adjacent region is formed of a material having lower thermal strain than that of the non-adjacent region.

10. The method according to claim 8, wherein the adjacent region is formed of Invar.

11. The method according to claim 8, wherein the non-adjacent region is formed of stainless steel or high-manganese steel.

12. The method according to claim 8, wherein the non-adjacent region is formed with corrugations and the adjacent region is not formed with corrugations.

13. The method according to claim 12, wherein, among the first membrane and the second membrane, the membrane comprising the adjacent region adjacent and the non-adjacent region formed of different materials comprises an end cap for preventing leakage of liquefied gas through the corrugations.

14. The method according to claim 8, wherein the liquid dome comprises: a liquid dome panel; and a liquid dome membrane, the liquid dome membrane comprising Invar.
